(19) United States
(12) Patent Application Publication
(10) Pub. No.: US 2006/0169786 A1
(43) Pub. Date: Aug. 3, 2006

(54) Manufacturing method of memory cards

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignee: Power Digital Card Co., Ltd.

(21) Appl. No.: 11/044,169

(22) Filed: Jan. 28, 2005

(51) Int. Cl. G06K 19/06

(52) U.S. Cl. 235/492

(57) ABSTRACT

The present invention provides a manufacturing method of memory cards, wherein contact terminals made from die molding are put on an injection machine for a plastic injection molding, so as to be embedded in a base made from a plastic injection molding method. After screening out imperfect products, chip modules (including flashing memories, control chips, and passive elements) are again put on the aforementioned base containing pre-embedded contact terminals, and finally the entire element is processed again by a plastic injection molding method, so as to completely wrap the chip modules, thereby sealing and isolating the chip modules wrapped in a plastic, improving current problems of fall-off and suffering from moisture, simplifying a manufacturing process, and reducing a manufacturing cost.

### BACKGROUND OF THE INVENTION

(a) Field of the Invention

The present invention relates to a manufacturing method of memory cards, and more particularly to a manufacturing method of memory cards for storing, accessing, and deleting data for a computer or its peripheral equipments.

(b) Description of the Prior Art

As the continuous advancement of modern computer technology, memory cards have become a personal belonging for most computer users to mainly use as storage media of digital peripheral products. Comparing with a floppy disk, the memory card is small in size. However, the memory card has a capacity which is much greater than that of the floppy disk, and has a fast accessing speed. Moreover, the memory card is not easy to be suffered from moisture or damage. Therefore, the memory card is gradually replacing the floppy disk having small capacity and large size.

Memory cards of all kinds of specifications of various dimension and size are released by vendors in the current market to fit digital products or computer peripheral equipments of different models, so as to provide application of data storage, accessing, and deleting for all kinds of computer devices.

A conventional manufacturing method of memory cards is to install flash memories, control chips, passive elements, etc. on a base, and to connect to an input/output contact terminal in front of the base, in order to constitute a necessary circuit. Finally, a casing is bond on the base by a supersonic fusing, or through an embossing or dispensing. Although the aforementioned structure can achieve a basic assembly, the following shortcomings still require to be improved upon using:
1. The contact terminal used for inputting/outputting a signal is made by continuously die molding a metallic copper plate, and then put in front of a memory card made by plastic injection molding. As this kind of procedure still requires positioning the molded contact terminal on the base, the procedure of assembling is complex, and the imperfection rate is often increased by man made mistakes.
2. For the memory card manufactured by a base and a casing, as the embedded memory package elements are unable to be completely isolated from outside, the memory card is easy to be suffered from moisture, causing insufficient reliability and durability, and the problem of falling-off. Although a vendor has used a filling material to fill inside the memory cards, as disclosed in Taiwan new patent 556908, to prevent moisture from entering and thus affecting the reliability of the memory cards, the manufacturing process is complex and the manufacturing cost is increased.

### SUMMARY OF THE INVENTION

The primary object of the present invention is to provide a manufacturing method of memory cards, wherein the memory card is directly made by plastic injection molding, to completely wrap a chip module (including flash memories, control chips, and passive elements) inside the memory card into a plastic, thereby sealing the chip module embedded in the plastic, and achieving an isolation effect, in order to improve the reliability and firmness of the memory cards.

Another object of the present invention is to directly embed the contact terminals and chip modules with plastic injection molding, to simplify the manufacturing procedure, and in turn decrease the manufacturing cost.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram of manufacturing of an implementation of the present invention.

FIG. 2 shows a schematic view of a structure of a memory card of the present invention.

FIGS. 3, 4, and 6 show a schematic view of manufacturing procedure of a memory card of the present invention.

FIG. 5 shows an flow diagram of manufacturing of another implementation of the present invention.

### DETAILED DESCRIPTION OF THE PREFERRED EMBODIMENTS

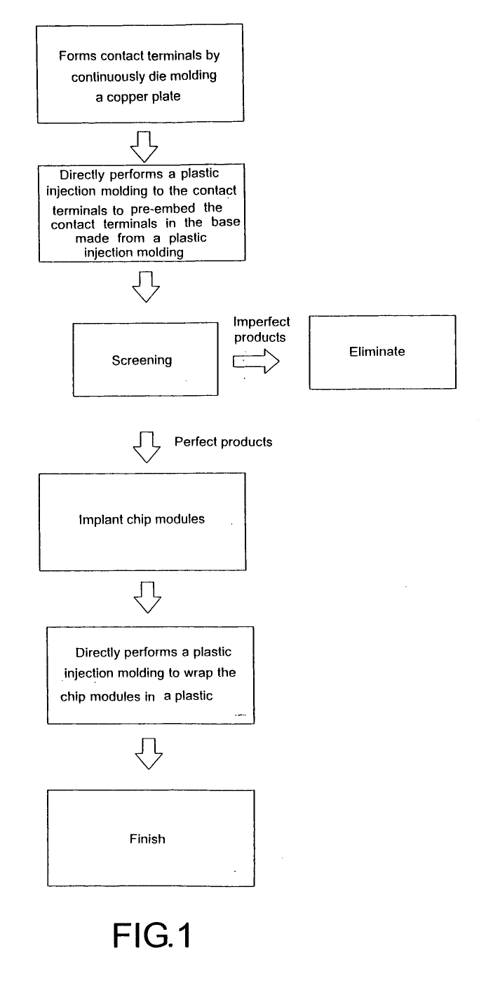

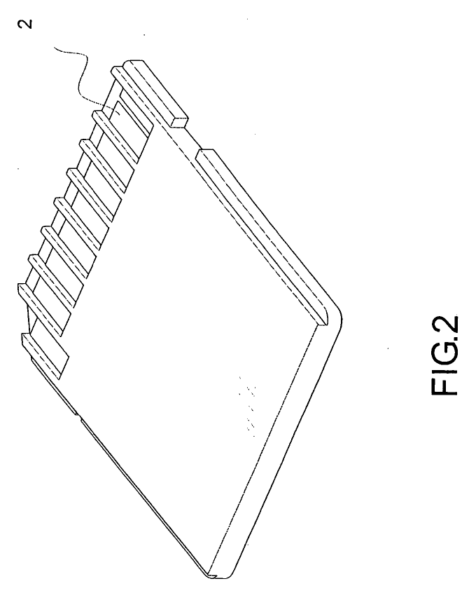

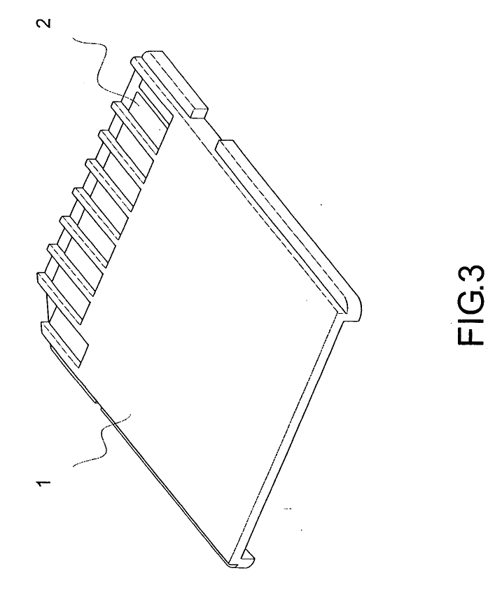

Referring to FIG. 1, which shows a flow diagram of manufacturing of an implementation of the present invention, and referring to other drawings, the present invention (as shown in FIG. 2) comprises primarily a base 1 and a plurality of chip modules 3 (including flashing memories, control chips, and passive elements) on the base 1, constituting a circuit with contact terminals 2 in front of the base 1. The improved process of manufacturing of the present invention lies in that after manufacturing the contact terminals 2 by continuously die molding a copper plate with a punch, the contact terminals 2 are directly processed with a plastic injection molding method on a plastic injection machine, so as to pre-embed the contact terminals 2 in the base 1 (as shown in FIG. 3) made from a plastic injection molding method. This manufacturing method can remove a man made assembling of the base 1 and the contact terminals 2, which simplifies the manufacturing process, thereby reducing a manufacturing cost. After accomplishing the aforementioned procedure, imperfect semi-manufactured products from the plastic injection molding are first screened out, to avoid re-implanting the imperfect products into the high-value chip modules 3, thereby causing an imperfection rate and increasing a cost.

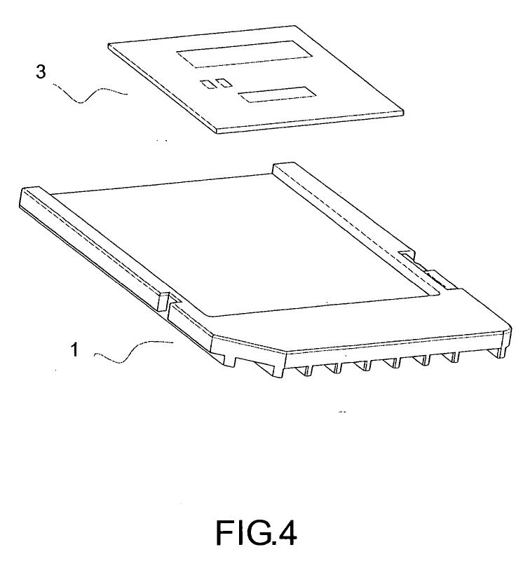

After screening out, the chip modules 3 (including flashing memories, control chips, and passive elements) are implanted into the perfect base 1 made from the plastic injection molding, and made a circuit connection with the contact terminals 2 in front of the base 1. Then, a casing 4 is covered on a top of the base 1 (as shown in FIG. 4), in order to hold the chip modules 3 between the casing 4 and the base 1.

Finally, a plastic injection molding is performed once again on the aforementioned structure, to completely seal a gap between the casing 4 and the base 1, so as to assure that the chip modules 3 in the memory card are sealed and isolated, thereby effectively isolating an intrusion of moisture and water, increasing the reliability of memory cards, and improving the problem of fall-off.

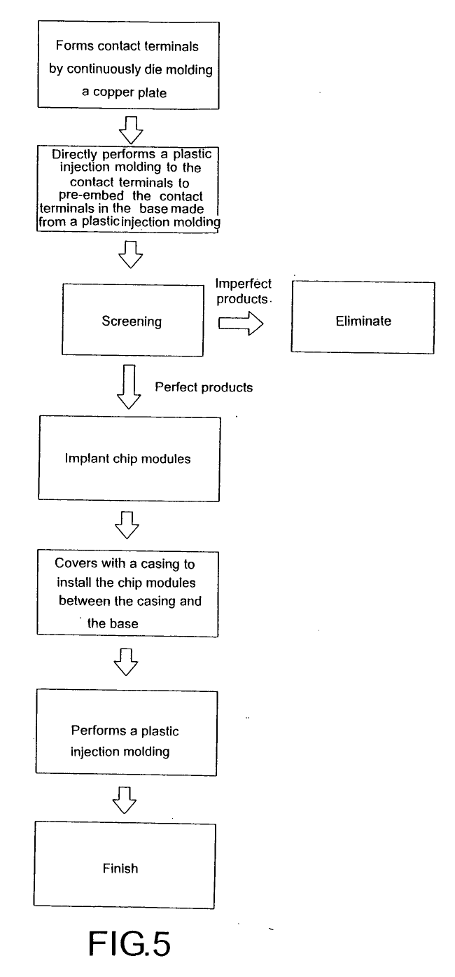

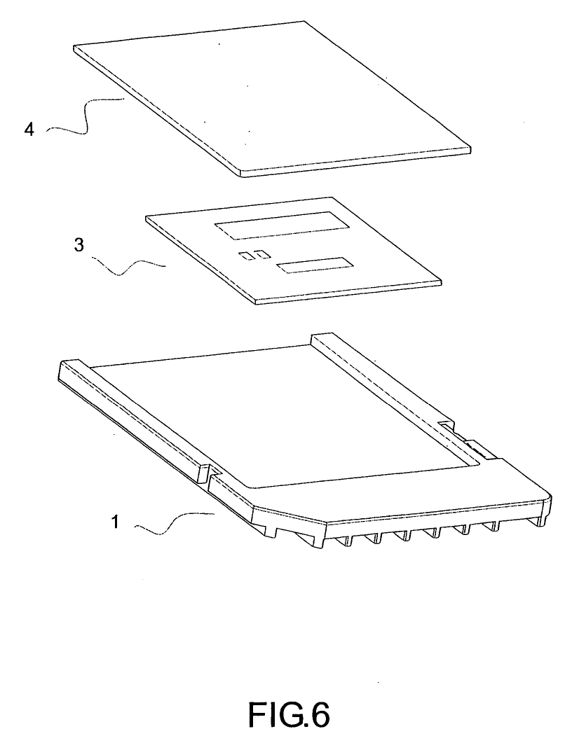

Referring to FIG. 5, it shows a flow diagram of manufacturing of another implementation of the present invention. The difference of this manufacturing process with the aforementioned process is that the casing 4 is not involved in this manufacturing process, but a plastic injection molding is directly performed after implanting the chip modules 3 in the base 1, so as to further simplify the manufacturing process. The rest part of the process is the same as that of the aforementioned process (as shown in FIG. 6).

Accordingly, the present invention uses a simple method to completely seal and wrap the chip modules in the memory cards, so as to assure that the chip modules in the memory cards are sealed and isolated, thereby simplifying the manufacturing process, reducing the imperfection rate, and decreasing the cost.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A manufacturing method of memory cards including primarily a base and a plurality of chip modules formed by passive elements, flashing memories, and control chips installed on the base, forming a circuit connection by the chip modules and contact terminals in front of the base; the aforementioned base containing chip modules made directly by a plastic injection molding method to wrap the chip modules on the base in a plastic, assuring that the chip modules are sealed and isolated.

2. The manufacturing method of memory cards according to claim 1, wherein the contact terminals are made by a plastic injection molding method to be embedded in the base.

3. A manufacturing method of memory cards including primarily a base and a plurality of chip modules formed by passive elements, flashing memories, and control chips, forming a circuit connection by the chip modules and contact terminals in front of the base; a casing installed on a top of the base, forming a sealed chip modules; after accomplishing the aforementioned structure, a plastic injection molding once again performed to completely seal a gap between the casing and the base, assuring that the chip modules in the memory cards are sealed and isolated.
